(19) United States
(12) Patent Application Publication
(10) Pub. No.: US 2022/0034520 A1
(43) Pub. Date: Feb. 3, 2022

(54) PRECAST RADIANT FLOOR MODULES AND FLOOR SYSTEMS

(71) Applicant: Clark Pacific, A California General Partnership, West Sacramento, CA (US)

(72) Inventor: Jon Mohle, Sacramento, CA (US)

(73) Assignee: Clark Pacific, A California General Partnership, West Sacramento, CA (US)

(21) Appl. No.: 16/944,961

(22) Filed: Jul. 31, 2020

(51) Int. Cl. F24D 3/14; E04B 5/48

(52) U.S. Cl. CPC F24D 3/142; E04B 5/48

(57) ABSTRACT

A precast floor system and precast radiant floor modules provide an alternative to conventional radiant systems that are installed in the field. Radiant circuits are embedded in concrete floor planks when they are precast, thereby forming precast radiant floor modules. The radiant circuits can be pre-configured into multiple temperature-controlled zones in the floor plank. The precast floor system is assembled by arranging ribbed and non-ribbed precast radiant floor modules in an alternating configuration where non-ribbed precast radiant floor modules are supported along their edges by the ribs on the ribbed precast radiant floor modules.

### CROSS-REFERENCE TO RELATED APPLICATIONS

Not Applicable

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to radiant heating and cooling systems in commercial buildings, and more particularly to precast concrete floor planks that are factory configured with embedded fluidic circuits for heating or cooling.

### 2. Background Discussion

Many commercial buildings are constructed with forced air heating ventilation and cooling (HVAC) systems. However, radiant heating and cooling systems are well known alternatives that can provide superior thermal and acoustic comfort, lower energy demand and less maintenance.

A problem with radiant systems is that that they are installed in the field, the installation process is complex, and the installation can require close coordination between several trades, which generally drives up the cost of the system. Advocates of radiant systems promote the increased comfort and productivity within the space as justification for the higher cost of the system. Still, installation complexity and cost remain as concerns.

Therefore, there is a need for a system that provides the benefits of traditional radiant systems but can be installed more easily and at a lower cost than conventional radiant systems.

### BRIEF SUMMARY

This disclosure describes a precast floor system and its components that provide an alternative to conventional radiant systems that are fabricated onsite during building construction. In one embodiment, concrete floor planks are precast offsite and radiant circuits are embedded in the floor planks when they are precast, thereby forming precast radiant floor modules. The radiant circuits can be pre-configured into multiple temperature-controlled zones when the floor plank is precast. In one embodiment the precast radiant floor modules are flat. In one embodiment, the precast radiant floor modules include ribs along their sides for support a flat (non-ribbed) precast radiant floor module. In one embodiment, a precast floor system is assembled by arranging ribbed and non-ribbed precast radiant floor modules in an alternating configuration where non-ribbed precast radiant floor modules are supported along their edges by the ribs on the ribbed precast radiant floor modules. Accordingly, the technology of this disclosure addresses many of the issues associated with installation of radiant systems used in commercial building construction. Precast floor planks that contain one or more embedded radiant circuits will reduce construction complexity, time and costs.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1A is a schematic top view of a ribbed precast radiant floor module according to an embodiment of the present disclosure, where the hidden lines depict partially embedded heating or cooling tubes as well as manifolds and non-embedded portions of the tubes on the underside of the floor module.

FIG. 1B is a cross section of the ribbed precast radiant floor module of FIG. 1A, and shows support ribs astride the planar portion of the concrete plank with heating or cooling tubes partially embedded in the concrete plank.

FIG. 1C is schematic bottom view of the ribbed precast radiant floor module of FIG. 1A, where hidden lines depict partially embedded heating or cooling tubes and wherein solid lines depict the manifolds and non-embedded portions of the tubes on the underside of the floor module.

FIG. 2 is a bottom view of the ribbed precast radiant floor module of FIG. 1A through FIG. 1C, where the floor module is shown attached to building supply and return lines to provide the fluid for heating or cooling, and where the manifolds and non-embedded portions of the tubes connected to the manifolds are also shown.

FIG. 3 is a perspective bottom view of a non-ribbed precast radiant floor module (left) and a ribbed precast radiant floor module (right) according to the present disclosure, with tubes and manifolds removed for clarity.

FIG. 4 is a section view of an assembly of a non-ribbed precast radiant floor module astride and supported by two ribbed precast radiant floor modules according to the embodiment of the present disclosure.

FIG. 5A is a schematic perspective view of a building framework of pylons and beams, upon which have been installed a plurality of ribbed and non-ribbed precast radiant floor modules in an alternating configuration according to an embodiment of the present disclosure.

FIG. 5B is a schematic perspective view of the underside of a portion of the building framework of FIG. 5A, showing the ribbed and non-ribbed precast radiant floor modules installed in an alternating configuration according to an embodiment of the present disclosure.

FIG. 5C is a detailed schematic bottom view of a portion of the building framework of FIG. 5B showing ribbed and non-ribbed precast radiant floor modules installed in an alternative configuration according to an embodiment of the present disclosure, and illustrating how control modules can be configured to control the flow of heating or cooling fluid to two adjacent radiant floor modules according to an embodiment of the present disclosure.

### DETAILED DESCRIPTION

By way of example, and not of limitation, the technology of this disclosure comprises a modular floor system and precast floor modules with embedded radiant circuits. In one embodiment, the modular floor system comprises an assembly of alternating ribbed planks and flat planks. The precast floor modules are configured as either ribbed or non-ribbed planks to be used in that assembly. The modular floor system and precast floor modules are intended for use in commercial building construction but can be applied to building construction of any type where radiant systems are used.

1. Precast Radiant Floor Modules

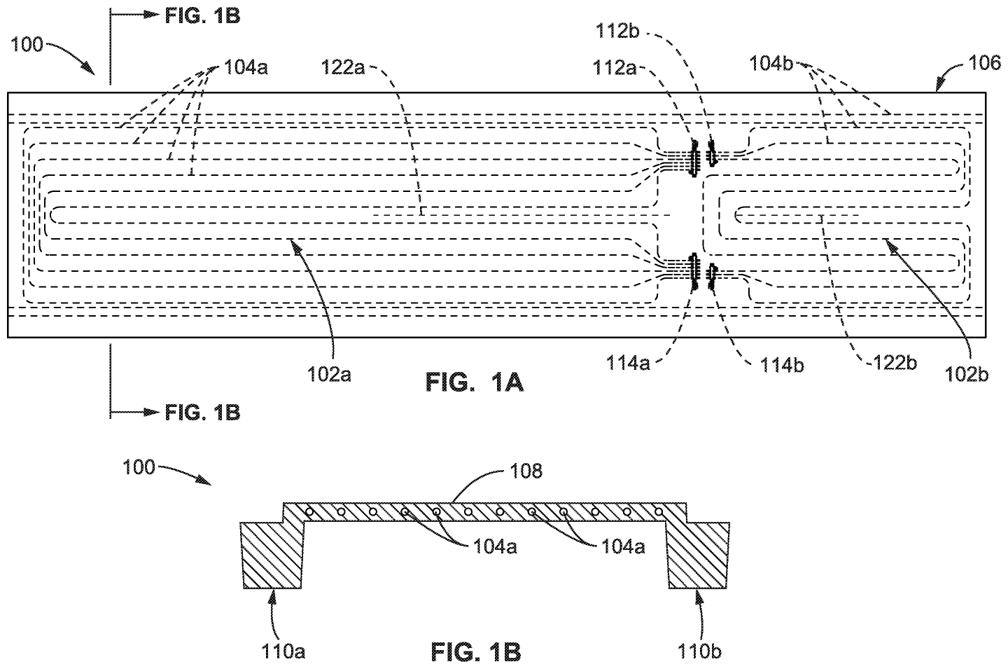

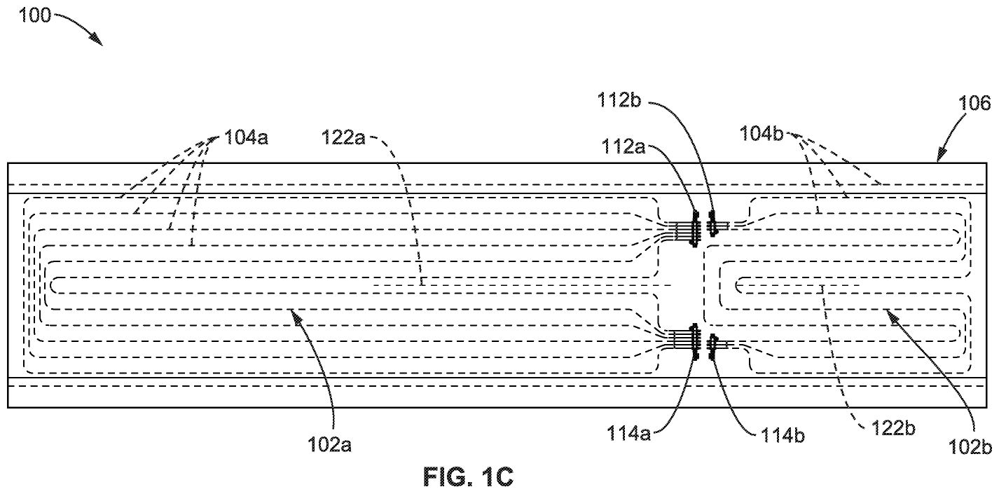

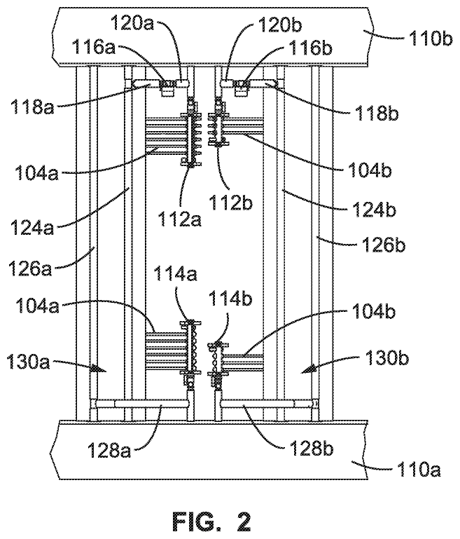

Referring first to FIG. 1A through FIG. 1C and FIG. 2, precast radiant floor modules according to presented technology will now be described. A radiant floor module can be precast as either a ribbed plank or as a flat (non-ribbed) plank. For ease of presentation, the ribbed embodiment of a precast radiant floor module will be described in detail. The flat plank embodiment has the same configuration except that it excludes the ribs.

FIG. 1A is a schematic top view of an embodiment of a ribbed precast radiant floor module 100 according to the technology of this disclosure. In this embodiment, the floor module includes two radiant zones, one of which is configured as a temperature-controlled inner zone 102a and the other of which is configured as a temperature controlled outer zone 102b. The two zones 102a, 102b are defined by a plurality of tubes 104a, 104b, respectively, which are partially embedded in a precast concrete floor structure 106 to form the floor module 100.

As used herein, the term “partially embedded” is intended to mean that the tubes are encapsulated in the concrete except for ends of the tubes that are exposed a sufficient length for connection to supply and return lines. The portion of tubes 104a, 104b depicted in hidden lines illustrates that the tubes are embedded in the precast concrete floor structure 106. Since FIG. 1A is a top view of the floor module, no portion of the tubes is shown exposed in that figure. The bottom view in FIG. 1C shows where ends of the tubes are exposed and can be seen from the underside of the floor module.

An important feature of the presented technology is that that the floor modules are precast and that the tubes are embedded during casting. This process takes place offsite so that the floor modules can be delivered to the job site as integrated units that are ready for assembly. It is understood that the precast concrete floor structure may be prestressed or not prestressed. For optimal concrete performance in a factory setting, however, it would likely be that the concrete would be prestressed. Such design and fabrication would enable spans as great as about 55 to about 60 feet.

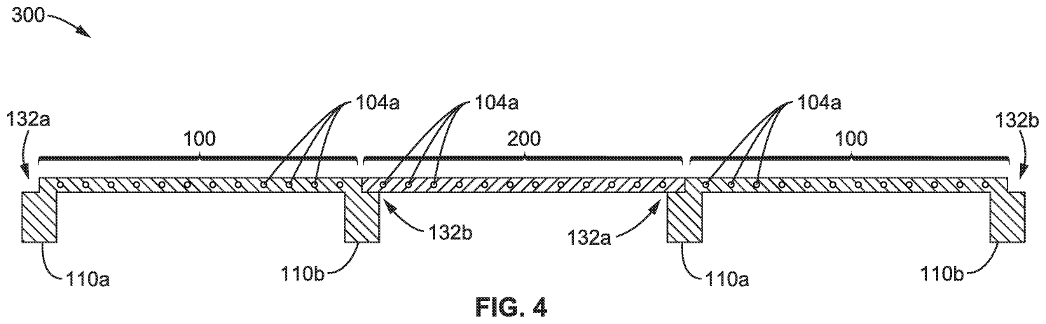

FIG. 1B schematically shows a cross-section of the precast radiant floor module 100. From FIG. 1B it can be seen that the precast concrete floor structure 106 generally comprises a concrete floor plank 108 with ribs 110a, 110b running along the length the plank. The plank and ribs are not separate components but are cast as integrated portions of the floor module. The ribs provide structural support for the concrete floor plank 108, and also provide “ledges” 132a, 132b along the length of the plank to support adjacent non-ribbed (flat) floor planks in an alternating assembly. As indicated previously, the floor system comprise an alternating assembly of “ribbed” and “non-ribbed” precast radiant floor modules (FIG. 4).

As can be seen, therefore, the floor module thus illustrated and described is a precast structure comprising a plank 108 bordered by ribs 110a, 110b and radiant circuits embedded in plank 108. This is a “ribbed” precast radiant floor module according to the presented technology. A “non-ribbed” precast radiant floor module according to the presented technology simply has the ribs omitted.

Referring again to FIG. 1A, the temperature-controlled zone 102a is referred to herein as an inner thermal control zone, as it would ordinarily be oriented toward the inside of a building where it would be installed. Similarly, the temperature controlled zone 102b is referred to herein an outer thermal control zone, as it would ordinarily be oriented toward the outside of the building (e.g., where the windows are located). Temperature control of the inner zone 102a and outer zone 102b is maintained by separate flows of heated or cooled fluid through the partially embedded tubes 104a, 104b, respectively.

The zone configuration described above is preferred because buildings tend to have better thermal regulation towards the interior, and relatively worse regulation toward the exterior walls and windows where there tend to be greater heating and cooling loads. Therefore, the shorter outer thermal control zone 102b would be appropriate toward the exterior of a building. It will be appreciated, however, that the technology described herein is not limited to two zones but is applicable to single zone systems as well as systems with three or more zones.

Referring also to FIG. 1C, the tubes 104a, 104b are at least partially embedded in the concrete floor plank 108. This partial embedding allows for the bulk of the tubes 104a, 104b to be in thermal contact with the concrete floor plank 108 for heat transfer purposes, and for integration with the overall precast radiant floor module 100.

Heating or cooling of the temperature-controlled zones 102a, 102b is achieved by fluid flowing through the tubes 104a, 104b, respectively. Each of the tubes 104a, 104b has a supply terminus and a return terminus that respectively terminate in a supply manifold 112a, 112b and a return manifold 114a, 114b.

Referring also to FIG. 2, flow controllers 116a, 116b can be installed during onsite assembly of the floor system to control fluid flow through the tubes. For example, in one embodiment of a floor system the flow controllers 116a, 116b would be connected to input feed lines 118a, 118b, respectively, and provide to manifolds 112a, 112b through output feed lines 120a, 120b, respectively. Accordingly, the flow controllers are capable of controlling fluid flow through the embedded tubes thereby establishing the temperature-controlled zones. In order to reduce cost, the same set of flow controllers can be used to control an adjacent module by connecting the output feed lines to the manifolds for both modules.

In one embodiment, temperature control of the zones 102a, 102b can be achieved by monitoring a temperature sensor 122a, 122b, respectively, and reducing or increasing fluid flow to maintain the desired temperature. This could be done, for example, using a simple thermostat or a more complicated feedback based controller connected to a temperature sensor and its corresponding flow controller. The temperature sensors may be positioned at locations selected from a group of locations consisting of: the concrete plank, the tube, the supply manifold, the return manifold, and the flow controller. In this non-limiting example, the temperature sensors are in the approximate middle of the temperature-controlled zones.

In the configuration shown in FIG. 2, the output feed lines 120a, 120b are attached to inputs of the supply manifolds 112a, 112b, respectively. The input feed lines 118a, 118b are connected to supply lines 124a, 124b, respectively. Heating or cooling fluid (typically, but without limitation, water) passes from the supply lines, through the flow controllers, through the supply manifolds, through the tubes, through the return manifolds, and finally to return lines 126a, 126b, respectively, through manifold return lines 128a, 128b, respectively. It will readily be understood that exposed portions of any of the lines can be insulated as necessary. It will also readily be understood that the flow controllers could alternatively be inserted at an output of return manifolds (not shown here).

It will be appreciated that tubes 104a, 104b typically would have simple cylindrical cross sections based on the standard meaning of the term “tube”. However, for the purposes of this disclosure, a tube merely comprises a structure having an interior cross section capable of conveying flow of a fluid. By this fluid conveyance, heating or cooling of the temperature-controlled zones may be accomplished. The tubes may be made from various materials, including, for example, thermoplastic materials, cross-linked polyethylene (PEX), metals, and copper. The tubes would preferably comprise a material that is not prone to leakage due to material degradation, stress, electrolysis, etc. Preferably the tubes are PEX because the material is more easily accepted by industry trade workers and unions.

The manifolds may include shutoff valves for each of the tubes in a circuit. The manifolds may also include valves for controlling the flow in each of the tubes for balancing. Additionally, the manifolds may have a flow rate monitoring capability, where the flow in one or more of the tubes can be determined. Those skilled in the art will appreciate that other features and flow control configurations can be employed as well.

2. Precast Radiant Floor Systems

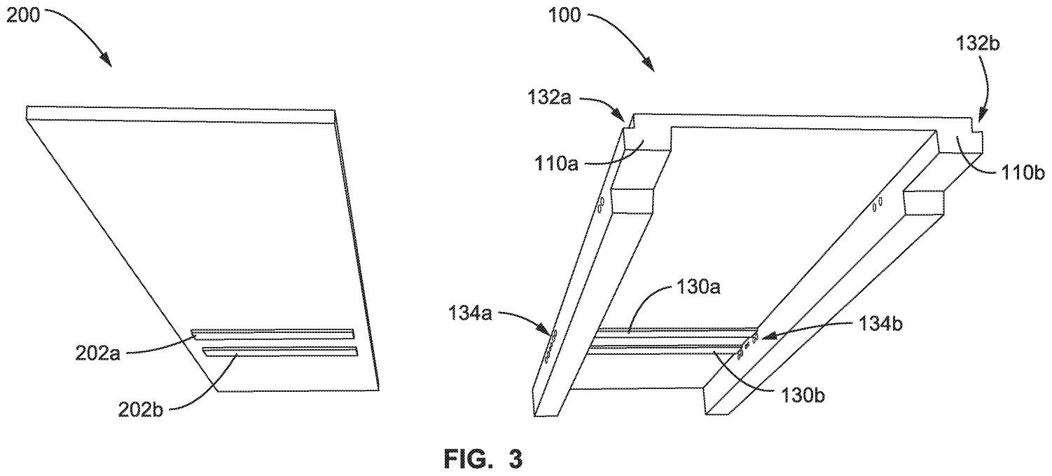

Referring to FIG. 3, an embodiment of a precast radiant floor system according to the presented technology comprises alternating ribbed floor modules 100 and non-ribbed (flat) floor modules 200. The floor modules comprise ribbed or non-ribbed slabs with a thickness sufficient to meet the strength, safety or other requirements for the building. For example, the slab thickness could be based on a particular fire separation requirement between floor levels such as zero to about two or more hours. Examples of thickness include from about 4 to about 5 inches. The slab thickness could also be selected to selected to provide a particular fire separation. The slabs can also be precast with sufficient reinforcement to accommodate a field cut opening, such as 24 inches, at any location without the need for supplemental support or reinforcement. Additionally, the ribbed floor modules:

(a) are intended to provide flexibility in the space by providing a long span office solution up to about 55 to about 60 foot beam spacing;

(b) may include a notch near the core to accommodate main duct runs in a thin story height;

(c) may be configured for a rib spacing of 10 feet on center (similar to steel construction); and

(d) may include standard rib penetrations for fire sprinkler and hydronic piping.

In one embodiment, this coordinated system may include thickened areas or strips 130a, 130b, 202a, 202b located about 15 feet from the outside end of the plank. These strips form interior pockets (not shown) that allow the radiant tubes to enter or exit the plank structure without the need for a slab recess. In one embodiment, the strips may be about 1½ inch to about 3 inches thick from the surface of the plank. Note that the lack of a slab access requirement is important, since a slab recess would compromise the fire rating and may require fire testing and likely an insulated cover plate. The thickened areas also provide a convenient mounting surface for the main hydronic pipe runs (supply and return lines), thereby allowing for simple inexpensive mounting of the pipes to the ceiling.

Common arguments against radiant systems include risk of future penetrations during to coring and other intrusions. In order to address the risk of future penetrations, the precast radiant floor module layout described herein may optionally utilize a micro-circuiting approach. In one embodiment, instead of using a small number of large diameter tubes, a plurality of small diameter tubes can be used in the inner and outer zones. For example, the inner zone may comprise about six circuits and the outer zone may comprise about three circuits. In this embodiment, the tubes would be approximately one-half inch in diameter. The benefit of this embodiment would that, if a tube is penetrated or otherwise fails, that circuit can be switched off locally. The circuit could then be abandoned (left off) or it could be rerouted or repaired while the module continues to run.

In one embodiment, manifolds are fully assembled with tubing and are pressure tested offsite. The manifolds are then hidden within a pocket in the form between the thickened areas when the floor module is precast. After the floor module is stripped from the casting forms, the manifolds can be permanently mounted to the underside of the precast radiant floor module in a ready to ship configuration. Onsite work is minimized and would then generally comprise, for example, installing (4) 2″ PEX pipes with (8) couplers and (4) short ¾″ PEX pipes with (4) couplers and (4) threaded adapters at each flat floor plank The water supply and return lines to the system would be installed and the lines insulated if desired.

Furthermore, referring to the components illustrated in FIG. 2 and described above, in one embodiment a ribbed precast radiant floor module can be fitted at the factory with a supply line and a return line. Openings 134a, 134b are provided in the ribs 110a, 110b, respectively, through which the supply and return lines can extend. In another embodiment, the ribbed module could be fitted at the factory with the supply lines, return lines, flow controllers, manifolds and their respective connections so that the ribbed module would essentially be complete “drop in place” unit when delivered to the construction site. Supply lines, return lines and their connections for the non-ribbed modules would then be added and connected at the construction site.

3. Building with Precast Radiant Floor System

FIG. 4 illustrates an assembly 300 comprising alternating ribbed 100 and non-ribbed 200 floor modules according to an embodiment of the presented technology. In the embodiment shown, a non-ribbed precast radiant floor module 200 is supported by the ledges 132a, 132b defined by the ribs 110a, 110b on adjacent ribbed precast radiant floor modules. By interleaving the ribbed and non-ribbed precast radiant floor modules, a floor deck may be readily constructed.

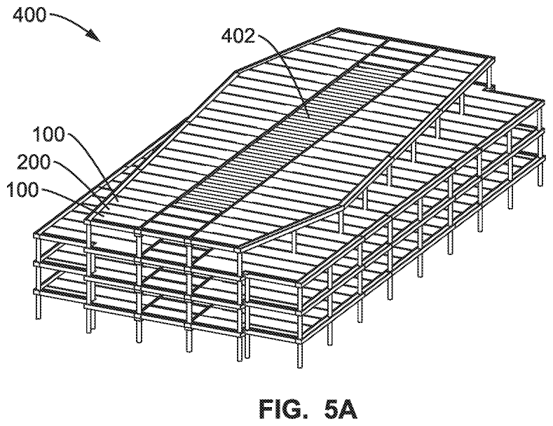

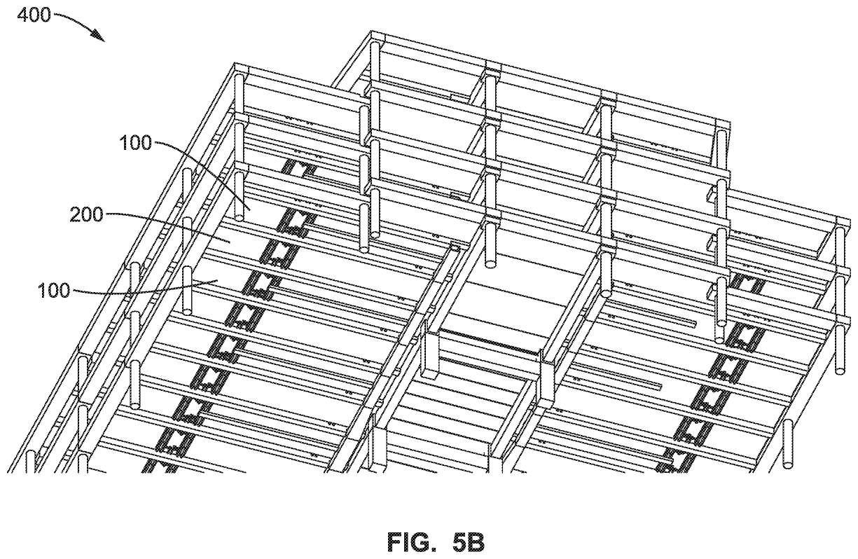

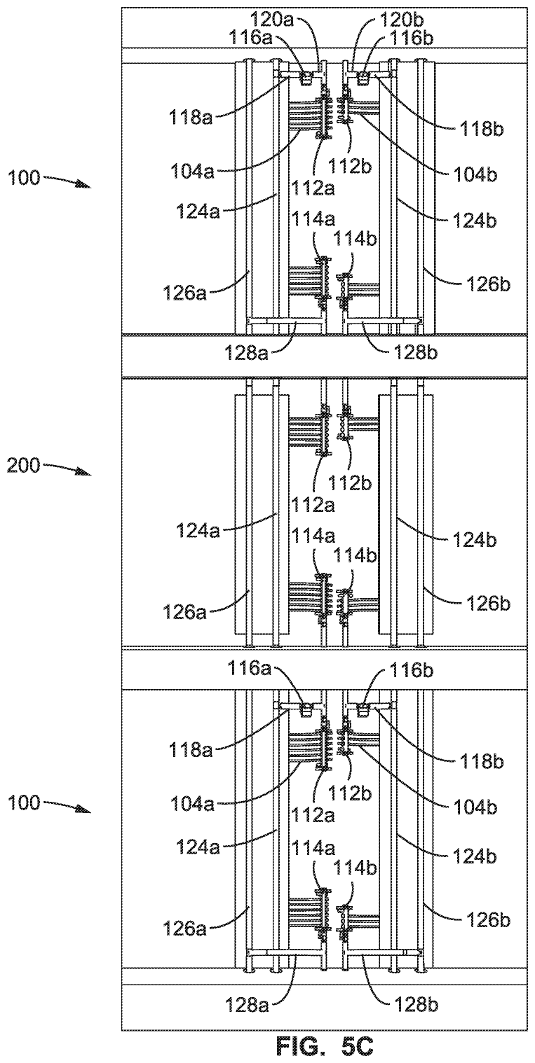

FIG. 5A is a perspective view of a building 400 showing a framework of columns and beams upon which have been installed a plurality of ribbed floor modules 100 and non-ribbed floor modules 200. Core building flooring 402 is shown as a reference to conventional flooring products. FIG. 5B is a perspective view of the underside of the building framework of FIG. 5A. Here, it is more apparent that the ribbed 100 and non-ribbed 200 modules are installed in an alternating fashion. FIG. 5C is a detailed view of a portion of the underside of building framework of FIG. 5B showing a non-ribbed precast radiant floor module 200 between two ribbed precast radiant floor modules 100 in an alternating configuration according to an embodiment of the present disclosure. In this embodiment, the flow controllers 116a, 116b installed on a ribbed precast radiant floor module control the flow of heating or cooling fluid to that module as well as to an adjacent non-ribbed precast radiant floor module.

Accordingly, from the description herein it will be appreciated that the present disclosure encompasses multiple embodiments which include, but are not limited to, the following:

1. A precast radiant floor module, comprising: (a) a precast concrete floor plank; and (b) a plurality of tubes at least partially embedded in the precast concrete floor plank, wherein the tubes are embedded during precast of the concrete floor plank; (c) said plurality of tubes arranged in a fluidic circuit; (d) each tube in the fluidic circuit having a supply terminus and a return terminus, wherein the supply terminus is configured for connection to a supply manifold and the return terminus is configured for connection to a return manifold.

2. The floor module of any preceding or following embodiment, wherein said fluidic circuit defines a temperature-controlled zone.

3. The floor module of any preceding or following embodiment, further comprising a temperature sensor embedded in the precast concrete floor plank, said temperature sensor positioned within the temperature-controlled zone.

4. The floor module of any preceding or following embodiment, wherein the temperature sensor is configured for temperature measurement of the temperature-controlled zone.

5. The floor module of any preceding or following embodiment, wherein the tubes comprise a material selected from the group consisting of a thermoplastic material, a cross-linked polyethylene (PEX) material, a metallic material, and copper.

6. The floor module of any preceding for following embodiment, further comprising: a supply manifold connected to the supply termini of the tubes in the fluidic circuit; and a return manifold connected to the return termini of the tubes in the fluidic circuit.

7. The floor module of any preceding or following embodiment: wherein the precast concrete floor plank has first and second sides, each side having a length; and wherein the precast concrete floor plank further comprises: a first rib along the length of the first side of the precast concrete floor plank; and a second rib along the length of the second side of the precast concrete floor plank.

8. A precast radiant floor module, comprising: (a) a precast concrete floor plank; and (b) a plurality of tubes at least partially embedded in the precast concrete floor plank, wherein the tubes are embedded during precast of the concrete floor plank; (c) said plurality of tubes arranged in a first fluidic circuit and a second fluidic circuit separate from the first fluidic circuit; (d) each tube in the first fluidic circuit having a supply terminus and a return terminus, wherein the supply terminus is configured for connection to a first supply manifold and the return terminus is configured for connection to a first return manifold; (e) each tube in the second fluidic circuit having a supply terminus and a return terminus, wherein the supply terminus is configured for connection to a second supply manifold and the return terminus is configured for connection to a second return manifold.

9. The floor module of any preceding for following embodiment: wherein said first fluidic circuit defines a first temperature-controlled zone; and wherein said second fluidic circuit defines a second temperature-controlled zone.

10. The floor module of any preceding for following embodiment, further comprising: a first temperature sensor embedded in the precast concrete floor plank, said first temperature sensor positioned within the first temperature-controlled zone; and a second temperature sensor embedded in the precast concrete floor plank, said second temperature sensor positioned within the second temperature-controlled zone.

11. The floor module of any preceding for following embodiment: wherein the first temperature sensor is configured for temperature measurement of the first temperature-controlled zone; and wherein the second temperature sensor is configured for temperature measurement of the second temperature-controlled zone.

12. The floor module of any preceding or following embodiment, wherein the tubes comprise a material selected from the group consisting of a thermoplastic material, a cross-linked polyethylene (PEX) material, a metallic material, and copper.

13. The floor module of any preceding or following embodiment, further comprising: a first supply manifold connected to the supply termini of the tubes in the first fluidic circuit; a first return manifold connected to the return termini of the tubes in the first fluidic circuit; a second supply manifold connected to the supply termini of the tubes in the second fluidic circuit; and a second return manifold connected to the return termini of the tubes in the second fluidic circuit.

14. The floor module of any preceding for following embodiment: wherein the precast concrete floor plank has first and second sides, each side having a length; and wherein the precast concrete floor plank further comprises: a first rib along the length of the first side of the precast concrete floor plank; and a second rib along the length of the second side of the precast concrete floor plank.

15. A precast modular radiant floor system, comprising: (a) a plurality of precast ribbed radiant floor modules; and (b) a plurality of precast non-ribbed floor modules; (c) wherein each said precast ribbed radiant floor module comprises: (i) a precast concrete floor plank, the precast concrete floor plank having first and second sides, each side having a length, a first rib along the length of the first side of the precast concrete floor plank, and a second rib along the length of the second side of the precast concrete floor plank; (ii) a plurality of tubes at least partially embedded in the precast concrete floor plank, wherein the tubes are embedded during precast of the concrete floor plank; (iii) said plurality of tubes arranged in a first fluidic circuit and a second fluidic circuit separate from the first fluidic circuit; (iv) each tube in the first fluidic circuit having a supply terminus and a return terminus, wherein the supply terminus is configured for connection to a first supply manifold and the return terminus is configured for connection to a first return manifold; (v) each tube in the second fluidic circuit having a supply terminus and a return terminus, wherein the supply terminus is configured for connection to a second supply manifold and the return terminus is configured for connection to a second return manifold; (d) wherein each said precast non-ribbed radiant floor module comprises: (i) a precast concrete floor plank having first and second sides; (ii) a plurality of tubes at least partially embedded in the precast concrete floor plank, wherein the tubes are embedded during precast of the concrete floor plank; (iii) said plurality of tubes arranged in a first fluidic circuit and a second fluidic circuit separate from the first fluidic circuit; (iv) each tube in the first fluidic circuit having a supply terminus and a return terminus, wherein the supply terminus is configured for connection to a first supply manifold and the return terminus is configured for connection to a first return manifold; (v) each tube in the second fluidic circuit having a supply terminus and a return terminus, wherein the supply terminus is configured for connection to a second supply manifold and the return terminus is configured for connection to a second return manifold; (e) wherein the precast ribbed radiant floor modules and precast non-ribbed radiant floor modules are arranged in an alternating pattern; and (f) wherein the sides of the precast concrete floor planks of the non-ribbed radiant floor modules are supported by ribs of adjacent precast ribbed radiant floor modules.

16. The floor system of any preceding for following embodiment: wherein each said first fluidic circuit in each said floor module defines a first temperature-controlled zone in said floor module; and wherein each said second fluidic circuit in each said floor module defines a second temperature-controlled zone in said floor module.

17. The floor system of any preceding or following embodiment: wherein each said precast concrete floor plank includes a first temperature sensor embedded in the precast concrete floor plank, said first temperature sensor positioned within the first temperature-controlled zone therein; and wherein each said precast concrete floor plank includes a second temperature sensor embedded in the precast concrete floor plank, said second temperature sensor positioned within the second temperature-controlled zone therein.

18. The floor system of any preceding for following embodiment: wherein the first temperature sensors are configured for temperature measurement of the first temperature-controlled zones; and wherein the second temperature sensors are configured for temperature measurement of the second temperature-controlled zones.

19. The floor system of any preceding for following embodiment: wherein the tubes comprise a material selected from the group consisting of a thermoplastic material, a cross-linked polyethylene (PEX) material, a metallic material, and copper.

20. The floor system of any preceding or following embodiment, wherein each said precast radiant floor module comprises: a first supply manifold connected to the supply termini of the tubes in the first fluidic circuit of said floor module; a first return manifold connected to the return termini of the tubes in the first fluidic circuit of said floor module; a second supply manifold connected to the supply termini of the tubes in the second fluidic circuit of said floor module; and a second return manifold connected to the return termini of the tubes in the second fluidic circuit of said floor module.

21. A precast radiant floor module, comprising: (a) a precast concrete structure, comprising: (i) a concrete floor plank; (ii) one or more tubes at least partially embedded in the concrete floor plank, each tube having a supply terminus and a return terminus; (iii) wherein each supply terminus terminates at a supply manifold; (iv) wherein each return terminus terminates at a return manifold; (b) a temperature-controlled zone, comprising: (i) a flow controller comprising an input and a controlled output coupled to the supply manifold; (ii) wherein the flow controller is configured to control flow to the supply manifold and through the tubes; (iii) wherein controlled flow through the tubes affects a temperature within the temperature-controlled zone.

22. The floor module of any preceding or following embodiment, wherein the flow controller is in fluid connection to an output of the return manifold.

23. The floor module of any preceding or following embodiment, wherein the tube comprises a cross section capable of conveying flow of a fluid.

24. The floor module of any preceding or following embodiment, wherein the precast concrete structure is prestressed.

25. The floor module of any preceding or following embodiment, further comprising a temperature sensor, wherein a temperature measurement representative of the temperature-controlled zone may be made.

26. The floor module of any preceding or following embodiment, wherein a location of the temperature measurement is selected from a group of locations consisting of: the concrete plank, the tube, the supply manifold, the return manifold, and the flow controller.

27. The floor module of any preceding or following embodiment, wherein the tube comprises a material selected from a group of materials consisting of: a thermoplastic, Cross-linked polyethylene (PEX), a metal, and copper.

28. The floor module of any preceding or following embodiment wherein the supply manifold comprises a valve controlling the flow of one or more tubes.

29. The floor module of any preceding or following embodiment, wherein the return manifold comprises a valve controlling the flow of one or more tubes.

30. The floor module of any preceding or following embodiment, wherein the supply manifold valve comprises a sight glass capable of displaying a flow rate of the flow in one or more tubes.

31. The floor module of any preceding or following embodiment, wherein the return manifold valve comprises a sight glass capable of displaying a flow rate the flow in one or more tubes.

32. The floor module of any preceding or following embodiment, wherein the flow controller is in flow connection with two or more supply manifolds.

33. The floor module of any preceding or following embodiment, wherein the flow controller is in flow connection with two or more return manifolds.

34. The floor module of any preceding or following embodiment, further comprising one or more ribbed tensile structures located at a side of the precast concrete structure.

35. The floor module of any preceding or following embodiment, further comprising two spaced apart ribbed tensile structures located at either side of the precast concrete structure, wherein the ribbed tensile structures act as supports for the precast concrete structure.

36. A precast radiant floor module, comprising: (a) a precast concrete structure, comprising: (1) a concrete floor plank; (2) one or more tubes at least partially embedded in the concrete floor plank, each tube having a supply terminus and a return terminus; and (b) a temperature sensor disposed within the concrete floor plank.

37. The floor module of any preceding or following embodiment, wherein the tube comprises a cross section capable of conveying flow of a fluid.

38. The floor module of any preceding or following embodiment, wherein the precast concrete structure is prestressed.

39. The floor module of any preceding or following embodiment, wherein the temperature measurement representative of a location in the concrete floor plank may be made.

40. The floor module of any preceding or following embodiment, wherein the tube comprises a material selected from a group of materials consisting of: a thermoplastic, Cross-linked polyethylene (PEX), a metal, and copper.

41. The floor module of any preceding or following embodiment, further comprising two spaced apart ribbed tensile structures located at either side of the precast concrete structure, wherein the ribbed tensile structures act as supports for the precast concrete structure.

42. The floor module or floor system of any preceding or following embodiment, wherein a ribbed precast radiant floor module further comprises a pre-installed supply line and a preinstalled return line.

43. The floor module or floor system of any preceding or following embodiment, wherein a ribbed precast radiant floor module further comprises a pre-installed supply line, a preinstalled return line, one or more flow controllers coupled to the supply line and to one or more supply manifolds, and one or more return manifolds coupled to the return line.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing group of elements, indicates that at least one of these group elements is present, which includes any possible combination of these listed elements as applicable.

References in this specification referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

As used herein, the term “set” refers to a collection of one or more objects. Thus, for example, a set of objects can include a single object or multiple objects.

As used herein, the terms “approximately”, “approximate”, “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A precast radiant floor module, comprising:
(a) a precast concrete floor plank; and
(b) a plurality of tubes at least partially embedded in the precast concrete floor plank, wherein the tubes are embedded during precast of the concrete floor plank;
(c) said plurality of tubes arranged in a fluidic circuit;
(d) each tube in the fluidic circuit having a supply terminus and a return terminus, wherein the supply terminus is configured for connection to a supply manifold and the return terminus is configured for connection to a return manifold.

2. The floor module of claim 1, wherein said fluidic circuit defines a temperature-controlled zone.

3. The floor module of claim 2, further comprising a temperature sensor embedded in the precast concrete floor plank, said temperature sensor positioned within the temperature-controlled zone.

4. The floor module of claim 3, wherein the temperature sensor is configured for temperature measurement of the temperature-controlled zone.

5. The floor module of claim 1, wherein the tubes comprise a material selected from the group consisting of a thermoplastic material, a cross-linked polyethylene (PEX) material, a metallic material, and copper.

6. The floor module of claim 1, further comprising:
a supply manifold connected to the supply termini of the tubes in the fluidic circuit; and
a return manifold connected to the return termini of the tubes in the fluidic circuit.

7. The floor module of claim 1:
wherein the precast concrete floor plank has first and second sides, each side having a length; and
wherein the precast concrete floor plank further comprises:
a first rib along the length of the first side of the precast concrete floor plank; and
a second rib along the length of the second side of the precast concrete floor plank.

8. A precast radiant floor module, comprising:
(a) a precast concrete floor plank; and
(b) a plurality of tubes at least partially embedded in the precast concrete floor plank, wherein the tubes are embedded during precast of the concrete floor plank;
(c) said plurality of tubes arranged in a first fluidic circuit and a second fluidic circuit separate from the first fluidic circuit;
(d) each tube in the first fluidic circuit having a supply terminus and a return terminus, wherein the supply terminus is configured for connection to a first supply manifold and the return terminus is configured for connection to a first return manifold;
(e) each tube in the second fluidic circuit having a supply terminus and a return terminus, wherein the supply terminus is configured for connection to a second supply manifold and the return terminus is configured for connection to a second return manifold.

9. The floor module of claim 8:
wherein said first fluidic circuit defines a first temperature-controlled zone; and
wherein said second fluidic circuit defines a second temperature-controlled zone.

10. The floor module of claim 9, further comprising:
a first temperature sensor embedded in the precast concrete floor plank, said first temperature sensor positioned within the first temperature-controlled zone; and
a second temperature sensor embedded in the precast concrete floor plank, said second temperature sensor positioned within the second temperature-controlled zone.

11. The floor module of claim 10:
wherein the first temperature sensor is configured for temperature measurement of the first temperature-controlled zone; and
wherein the second temperature sensor is configured for temperature measurement of the second temperature-controlled zone.

12. The floor module of claim 8, wherein the tubes comprise a material selected from the group consisting of a thermoplastic material, a cross-linked polyethylene (PEX) material, a metallic material, and copper.

13. The floor module of claim 8, further comprising:
a first supply manifold connected to the supply termini of the tubes in the first fluidic circuit;
a first return manifold connected to the return termini of the tubes in the first fluidic circuit;
a second supply manifold connected to the supply termini of the tubes in the second fluidic circuit; and
a second return manifold connected to the return termini of the tubes in the second fluidic circuit.

14. The floor module of claim 8:
wherein the precast concrete floor plank has first and second sides, each side having a length; and
wherein the precast concrete floor plank further comprises:
a first rib along the length of the first side of the precast concrete floor plank; and
a second rib along the length of the second side of the precast concrete floor plank.

15. A precast modular radiant floor system, comprising:
(a) a plurality of precast ribbed radiant floor modules; and
(b) a plurality of precast non-ribbed floor modules;
(c) wherein each said precast ribbed radiant floor module comprises:
(i) a precast concrete floor plank, the precast concrete floor plank having first and second sides, each side having a length, a first rib along the length of the first side of the precast concrete floor plank, and a second rib along the length of the second side of the precast concrete floor plank;
(ii) a plurality of tubes at least partially embedded in the precast concrete floor plank, wherein the tubes are embedded during precast of the concrete floor plank;
(iii) said plurality of tubes arranged in a first fluidic circuit and a second fluidic circuit separate from the first fluidic circuit;
(iv) each tube in the first fluidic circuit having a supply terminus and a return terminus, wherein the supply terminus is configured for connection to a first supply manifold and the return terminus is configured for connection to a first return manifold;
(v) each tube in the second fluidic circuit having a supply terminus and a return terminus, wherein the supply terminus is configured for connection to a second supply manifold and the return terminus is configured for connection to a second return manifold;
(d) wherein each said precast non-ribbed radiant floor module comprises:
(i) a precast concrete floor plank having first and second sides;
(ii) a plurality of tubes at least partially embedded in the precast concrete floor plank, wherein the tubes are embedded during precast of the concrete floor plank;
(iii) said plurality of tubes arranged in a first fluidic circuit and a second fluidic circuit separate from the first fluidic circuit;
(iv) each tube in the first fluidic circuit having a supply terminus and a return terminus, wherein the supply terminus is configured for connection to a first supply manifold and the return terminus is configured for connection to a first return manifold;
(v) each tube in the second fluidic circuit having a supply terminus and a return terminus, wherein the supply terminus is configured for connection to a second supply manifold and the return terminus is configured for connection to a second return manifold;
(e) wherein the precast ribbed radiant floor modules and precast non-ribbed radiant floor modules are arranged in an alternating pattern; and
(f) wherein the sides of the precast concrete floor planks of the non-ribbed radiant floor modules are supported by ribs of adjacent precast ribbed radiant floor modules.

16. The floor system of claim 15:
wherein each said first fluidic circuit in each said floor module defines a first temperature-controlled zone in said floor module; and
wherein each said second fluidic circuit in each said floor module defines a second temperature-controlled zone in said floor module.

17. The floor system of claim 16:
wherein each said precast concrete floor plank includes a first temperature sensor embedded in the precast concrete floor plank, said first temperature sensor positioned within the first temperature-controlled zone therein; and
wherein each said precast concrete floor plank includes a second temperature sensor embedded in the precast concrete floor plank, said second temperature sensor positioned within the second temperature-controlled zone therein.

18. The system of claim 17:
wherein the first temperature sensors are configured for temperature measurement of the first temperature-controlled zones; and
wherein the second temperature sensors are configured for temperature measurement of the second temperature-controlled zones.

19. The floor system of claim 15, wherein the tubes comprise a material selected from the group consisting of a thermoplastic material, a cross-linked polyethylene (PEX) material, a metallic material, and copper.

20. The system of claim 15, wherein each said precast radiant floor module comprises:
a first supply manifold connected to the supply termini of the tubes in the first fluidic circuit of said floor module;
a first return manifold connected to the return termini of the tubes in the first fluidic circuit of said floor module;
a second supply manifold connected to the supply termini of the tubes in the second fluidic circuit of said floor module; and
a second return manifold connected to the return termini of the tubes in the second fluidic circuit of said floor module.
